(19) United States
(12) Patent Application Publication
(10) Pub. No.: US 2004/0065649 A1
(43) Pub. Date: Apr. 8, 2004

(54) Method of manufacturing electrical contact surface having micropores

(76) Inventor: Izhak Etsion, Haifa (IL)

Correspondence Address: Mark Friedman, Bill Polkinghorn, Discovery Dispatch, 9003 Florin Way, Upper Marlboro, MD, 20772, US

(21) Appl. No.: 10/433,958

(22) PCT Filed: Dec. 7, 2001
(86) PCT No.: PCT/IL01/01135

(51) Int. Cl. B23K 26/14; B23K 26/00

(52) U.S. Cl. 219/121.68; 219/121.67; 219/121.69; 219/121.7

(57) ABSTRACT

A method of texturing a surface of an electrical contact including the steps of: (a) providing a first surface region for conducting electrical current; (b) providing a second surface region for conducing electrical current, the second surface region substantially opposing and operatively connected to the first surface region, and (c) utilizing beam radiation to form a plurality of micropores on at least one of the surface regions.

### FIELD AND BACKGROUND OF TE INVENTION

The present invention relates to electrical contact surfaces and, more particularly, to a method of producing an electrical contact surface containing micropores for improved current contact and conduction.

It is well known that two metal contact surfaces, disposed in parallel and held together, are subject to effects of vibration and fretting. Such contacts, which include battery terminal contacts and machinery control leads, undergo constant vibration and stres's, which cause fretting corrosion debris, usually in the form of metal oxides between the smooth surfaces of the contacts. These oxide particles are characteristically harder and may accelerate the wear of the contact. Such particles also possess high resistance, and as such, are inherently poor conductors of electrical current. The presence of such particles between the contact surfaces contributes often significantly—to power loss.

One approach to this detrimental phenomenon of particle accumulation in electrical connectors has been to utilize a layer of noble metal on the contact surfaces of the connector elements. Because noble metals do not substantially oxidize over time, the noble wear particles do not tend to increase the contact resistance as would occur if the particles were made of non-noble metal, e.g., copper or aluminum. Using such an approach, the high-conductivity copper material often has a layer of nickel applied thereto, which layer in turn has applied thereto another layer of a noble metal or a noble metal alloy, e.g., gold, gold-cobalt or other gold alloys, or platinum, palladium, iridium, or alloys thereof. The thickness of the layer and hardness of the material must be sufficient so as not to wear down too rapidly during the useful life of the connector.

Notwithstanding the electrical advantages offered by such noble metal or noble metal alloys, such electrical connectors are expensive. It is desirable, therefore, to develop a different approach that provides the desired low contact resistance and high reliability, but at a reasonable cost. Alternatively, it is desirable to develop an approach that allows the thickness of the noble metal layer to be reduced.

The imparting of depressions to an electrical contact surface as a means of maintaining a low resistance between contacts over the useful life of the connector is disclosed in U.S. Pat. No. 4,687,274 to Suh et al. The disclosed contact surfaces include square contact portions and depressed portions so that any wear particles produced are eventually swept from between the contact surfaces and entrapped in the depressed portions of the contact surfaces.

U.S. Pat. No. 4,687,274 to Suh et al. discloses various chemical and mechanical techniques for producing these surface characteristics, including photoresist, etching, plating and mechanical embossing processes. However, these processes often involve the use of hazardous chemicals, and may produce non-uniform patterns of the pits on the contact surfaces. Mechanical embossing creates undesired microscopic faults that may lead to corrosion and stress failure of the metal. Photoresist, etching and plating may produce unwanted changes in the microcrystalline structure of the contact metal, leaving a coating on the surface subsequently leading to electrochemical effects that are detrimental to the conductance of current or signals. Perhaps most importantly, these processes are all expensive and relatively complicated, in a field in which cost is of ever-increasing importance.

To date, there is no known industrial application of the improved contact conductivity invention disclosed in U.S. Pat. No. 4,687,274 to Suh et al.—utilizing any manufacturing method—the widespread need for such an invention notwithstanding. Despite impressive electrical conductivity results as compared with standard contact surfaces, in almost 15 years since U.S. Pat. No. 4,687,274 issued, the invention has not been commercially realized. It is manifestly evident that the primary reason behind the lack of commercial realization is the cost associated with the production of the specially-contoured contact surfaces.

In a completely unrelated art, that of load-bearing surfaces, the efficacy of micropores in increasing performance of non-contacting mechanical seals is taught by I. Etsion and L. Burstein (A Model for Mechanical Seals with Regular Microsurface Structure, Tribology Transactions, Volume 39 (1996), 3, pp.667-683). The authors show that hydrodynamically induced load-carrying capacity can be obtained as a sealing fluid passes across each seal face area having a hemispherical micropore.

U.S. Pat. No. 5,834,094 to Etsion and Kinrot discloses a method for designing bearings, of improved performance, the load-bearing surfaces of which feature micropores. The hydrodynamic pressure distribution of a suite of bearing surfaces with different micropore geometries and densities is modeled numerically. The load-bearing surfaces of the bearings are fabricated with micropores having the optimal density and geometry determined by the numerical modeling. It is emphasized that the hydrodynamic lift provided in liquid systems is based on the incompressibility of the liquid. Whereas the minimum pressure in the diverging region is limited by cavitation, the maximum pressure in the converging region is unlimited. It is this asymmetric behavior of the pressure curve that causes hydrodynamic lift.

The micropores are optimally on the order of several microns to several tens of microns deep and several tens of microns wide. It is disclosed by U.S. Pat. No. 5,834,094 that the use of a laser beam to create such micropores is known. It is further disclosed by U.S. Pat. No. 5,834,094 that one prominent application of such laser technology is BRITE-EURAM Proposal NR 5820, a research project sponsored by the Commission of the European Communities, to develop self-lubricating silicon carbide bearings. In this project, the lasers were used in a research mode, to create micropores of various controlled sizes, shapes, and density, in silicon carbide surfaces, in order to determine the optimal size, shape, and density to use in silicon carbide bearings.

U.S. Pat. No. 5,834,094 also teaches that lasers offer a convenient way to create micropores of specific shapes. A single laser pulse tends to create a substantially conical crater. A wide variety of shapes can be created by a suitable pattern of multiple pulses of carefully controlled location and energy.

The size of the micropores is controlled by changing the parameters of the optical system used to focus the laser beam onto the surface. The optical system includes an expanding telescope and a focusing lens. Varying the expansion ratio of the telescope and/or the focal length of the lens changes the area and power-density of the focal spot. Another parameter that is adjusted to control the micropore size is the pulse energy, which can be lowered from its peak value, by attenuation of the beam or by control of the laser power.

Moreover, the utilization of laser technology as a viable manufacturing technique was well known long before the issuing of U.S. Pat. No. 5,834,094. Laser micromachining methods and devices and laser beam welding methods and devices are known in the art for well over 20 years (e.g., U.S. Pat. Nos. 4,128,752 and 4,128,753). Another example is the use of a laser beam for fabricating micro-contours of battery plates, taught by U.S. Pat. No. 5,379,502.

There is thus a widely recognized need for, and it would be highly advantageous to have a method of manufacturing micropores in electrical contact surfaces, so as to produce high performance contact surfaces that maintain excellent conductivity over time, and are more simple and cost-effective to manufacture as compared with prior-art methods.

### SUMMARY OF THE INVENTION

According to the teachings of the present invention, there is provided a method of texturing a surface of an electrical contact including the steps of: (a) providing a first surface region for conducting electrical current; (b) providing a second surface region for conducting electrical current, the second surface region substantially opposing and operatively connected to the first surface region, and (c) utilizing beam radiation to form a plurality of micropores on at least one of the surface regions.

According to another aspect of the present invention, there is provided a method for utilizing an electrical contact including the steps of: (a) providing an electrical contact including: (i) a first surface region for conducting electrical current, and (ii) a second surface region for conducting electrical current, the second surface region substantially opposing the first surface region, wherein at least one of the surface regions has a plurality of micropores made by beam radiation, and (b) applying an electrical current to the electrical contact.

In a preferred embodiment, the beam radiation is laser beam radiation.

In another preferred embodiment, the plurality of micropores is designed and configured to entrap particles, thereby improving electrical conductivity.

In yet another preferred embodiment, both of the surface regions have a plurality of micropores.

In yet another preferred embodiment, the method further includes the step of: (c) trapping particles disposed between the surface regions in the micropores.

In yet another preferred embodiment, the pore geometry is substantially conical.

In yet another preferred embodiment, the pore geometry is substantially spherical.

In yet another preferred embodiment, the micropores are formed on the surface so as to cover between 20 area-% and 60 area-% of the surface.

In yet another preferred embodiment, the micropores cover between 40 area-% and 50 area-% of the surface.

In yet another preferred embodiment, the micropores have a depth of about 10 microns to about 80 microns.

In yet another preferred embodiment, the micropores have a depth of about 15 microns to about 50 microns.

In yet another preferred embodiment, at least some of the micropores have a depth of about 20 microns to about 40 microns.

In yet another preferred embodiment, the micropores have a diameter of about 75 microns to about 200 microns and a depth of about 10 microns to about 80 microns.

In yet another preferred embodiment, the micropores have a diameter of about 75 microns to about 200 microns and a depth of about 15 microns to about 50 microns.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A is a cross-sectional view of an electrical contact of the prior art;

FIG. 1B is the cross-sectional view of FIG. 1A, in which low-conductivity wear particles intervene between the two contact surfaces, and

FIG. 1C is a cross-sectional view of an electrical contact according to the present invention, in which a contact surface has laser-produced micropores in which several of the low-conductivity wear particles are entrapped.

### DESCRIPTION OF THE PREFERRED EMBODIMENTS

The principles of the method according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawing. The invention is capable of other embodiments or of being practiced or carried out in various ways. Also, it is to be understood that the phraseology and terminology employed herein is for the purpose of description and should not be regarded as limiting.

The present invention is a method of manufacturing electrical contact surfaces having micropores. The electrical contact is composed of two opposing surfaces, wherein one or more of the surfaces has a pattern of microscopic indentations.

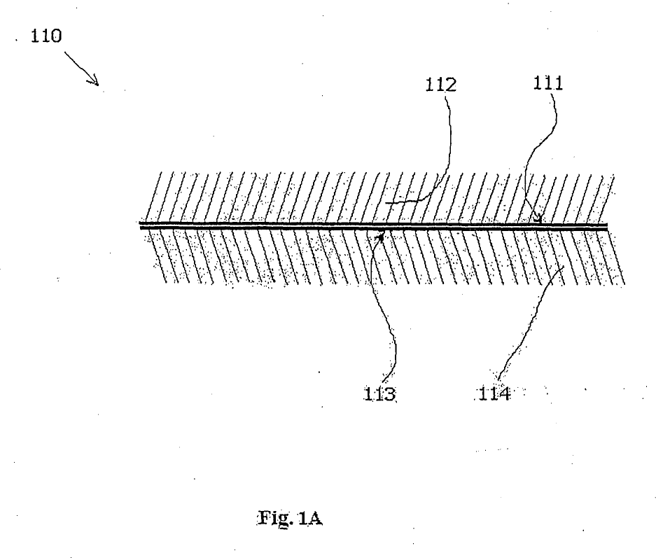

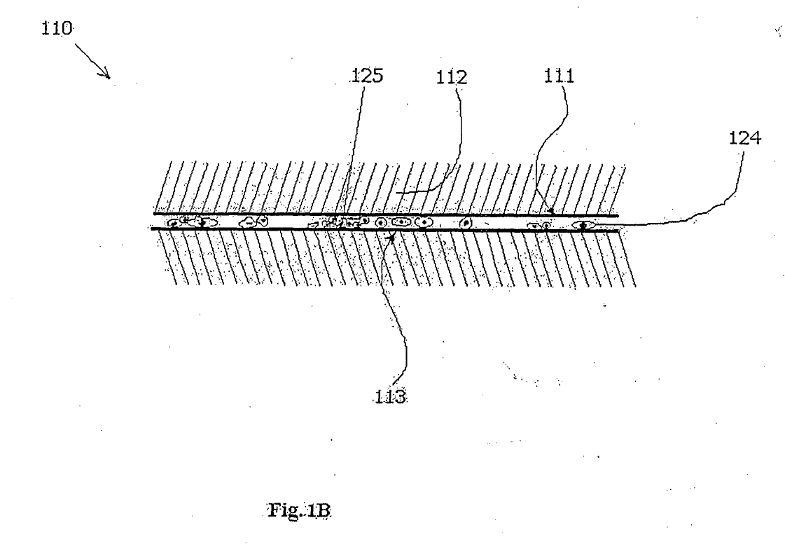

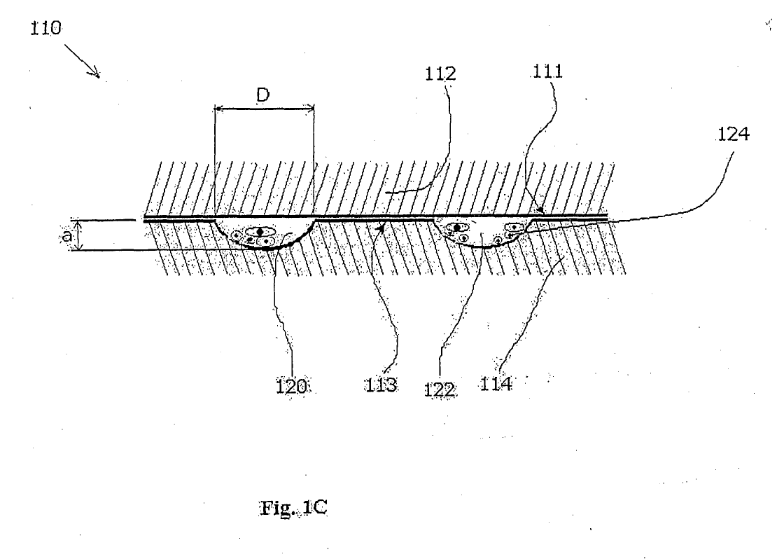

Referring now to the drawings, FIG. 1A is a cross-sectional view of an electrical contact 110 according to the prior art. Electrical contact 110 includes an upper surface 111 belonging to upper contact member 112 and a lower surface 113 belonging to lower contact member 114. Contact surfaces 111 and 113 are operatively connected so as to conduct an electrical current.

In FIG. 1B, poorly-conducting wear particles 124 are disposed between contact surfaces 111 and 113. The presence and build-up of such particles can greatly reduce the electrical conductivity over time. These particles tend to agglomerate to form large wear particles (e.g., large wear particle 125) and can even form a low conductivity layer between contact surfaces 111 and 113.

FIG. 1C is a cross-sectional view of an electrical contact in which a contact surface has a plurality of laser-produced micropores, according to the present invention. In lower surface 113 are disposed two concave micropores 120 and 122, of diameter D and depth a. Wear Particles such as wear particle 124, which are formed along contact surfaces 111 and 113, eventually make their way into micropores 120 and 122 in lower surface 113, as shown.

Pores 120 and 122 are preferably made in lower surface 113 by means of laser radiation. Laser radiation offers a convenient and inexpensive way of producing micropores of specific shapes. A single laser pulse tends to create a substantially conical crater. A wide variety of shapes can be created by a suitable pattern of multiple pulses of carefully controlled location and energy.

The shape of a substantially conical micropore created by a single laser pulse may be controlled by changing the laser beam profile. The laser beam profile is changed, either by inserting, in the optical path, apertures that create diffraction effects at the focal spot of the laser, or by allowing multi-mode operation of the laser beam to create a flat-top intensity profile. Another method is to use tailored optics, for example diffractive optics, to create flat-top or annular intensity profiles.

The size of the micropores is controlled by changing the parameters of the optical system used to focus the laser beam onto the surface. The optical system includes an expanding telescope and a focusing lens. Varying the expansion ratio of the telescope and/or the focal length of the lens changes the area and power density of the focal spot. Another parameter that is adjusted to control the micropore size is the pulse energy, which can be lowered from its peak value, by attenuation of the beam or by control of laser power.

As used herein in the specification and in the claims section that follows, the term “beam radiation” with regard to micropores, refers to a method of producing micropores in a surface by subjecting the surface to a beam, e.g., a photon beam (laser beam) or an ion beam.

It will be appreciated that the above descriptions are intended only to serve as examples, and that many other embodiments are possible within the spirit and the scope of the present invention.

What is claimed is:

1. A method of texturing a surface of an electrical contact, the method comprising the steps of:
(a) providing a first surface region for conducting electrical current;
(b) providing a second surface region for conducting electrical current, said second surface region substantially opposing and operatively connected to said first surface region, and
(c) utilizing beam radiation to form a plurality of micropores on at least one of said surface regions, said micropores having a pore geometry.

2. The method of claim 1, wherein said beam radiation is laser beam radiation.

3. The method of claim 1, wherein said pore geometry is substantially conical.

4. The method of claim 1, wherein said pore geometry is substantially spherical.

5. The method of claim 1, wherein said micropores are formed on said surface so as to cover between 20 area-% and 60 area-% of said surface.

6. The method of claim 5, wherein said micropores cover between 40 area-% and 50 area-% of said surface.

7. The method of claim 1, wherein at least some of said micropores have a diameter of at least about 150 microns.

8. The method of claim 1, wherein at least some of said micropores have a depth of about 10 microns to about 80 microns.

9. The method of claim 8, wherein at least some of said micropores have a depth of about 15 microns to about 50 microns.

10. The method of claim 8, wherein at least some of said micropores have a depth of about 20 microns to about 40 microns.

11. The method of claim 1, wherein said micropores have a diameter of about 75 microns to about 200 microns and a depth of about 10 microns to about 80 microns.

12. The method of claim 1, wherein said micropores have a diameter of about 75 microns to about 200 microns and a depth of about 20 microns to about 50 microns.

13. A method for utilizing an electrical contact, the method comprising the steps of:
(a) providing an electrical contact including:
(i) a first surface region for conducting electrical current, and
(ii) a second surface region for conducting electrical current, said second surface region substantially opposing said first surface region,
wherein at least one of said surface regions has a plurality of micropores made by beam radiation, and
(b) applying an electrical current to said electrical contact.

14. The method of claim 13, wherein said beam radiation is laser beam radiation.

15. The method of claim 14, said plurality of micropores being designed and configured to entrap particles, thereby improving electrical conductivity.

16. The method of claim 14, wherein both of said surface regions have a plurality of said micropores.

17. The method of claim 14, further comprising the step of:
(c) trapping particles disposed between said surface regions in said micropores.
